(19) United States
(12) Patent Application Publication
(10) Pub. No.: US 2018/0104712 A1
(43) Pub. Date: Apr. 19, 2018

(54) DIGITAL DISPENSING SYSTEM FOR FLOWABLE COMPOSITIONS

(71) Applicants: Ramiro M. Perez, Folsom, CA (US); Maryam Amiri, Folsom, CA (US)

(72) Inventors: Ramiro M. Perez, Folsom, CA (US); Maryam Amiri, Folsom, CA (US)

(21) Appl. No.: 15/842,721

(22) Filed: Dec. 14, 2017

Related U.S. Application Data
(63) Continuation of application No. 15/086,934, filed on Mar. 31, 2016.
(60) Provisional application No. 62/286,302, filed on Jan. 22, 2016.

(51) Int. Cl. B05B 11/02; G01G 19/52; G01G 23/36

(52) U.S. Cl. CPC B05B 11/025; G01G 19/52; G01G 23/36

(57) ABSTRACT

Example embodiments relate to a power-driven, digitally metered dispenser where cylindrical piston driven jar dispensers of varying diameters are used for transferring repeatable and specific amounts of flowable composition into smaller containers, like HRTicker® dispensers, applicators, pumps, syringes, and jars. Dosing is accomplished by dialing the desired dosage and the pressing of a push-button to dispense. The various example embodiments consist of a motor powered threaded plunger that travels in the vertical axis in accordance with a predetermined and programmed linear displacement. The end user dials the desired dispensation into the computers program via a main control dial.

### REFERENCE TO PRIORITY PATENT APPLICATIONS

The present application is a continuation of U.S. patent application Ser. No. 15/086,934; filed Mar. 31, 2016; which is a non-provisional patent application claiming priority to U.S. provisional patent application Ser. No. 62/286,302, filed on Jan. 22, 2016. The present non-provisional patent application claims priority to the referenced patent applications, which are hereby incorporated by reference herein in their entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014-2016 Ramiro M. Perez, All Rights Reserved.

### TECHNICAL FIELD

The various embodiments described herein relate to metered dispensers for transferring flowable compositions into smaller containers. In particular, various embodiments relate to power-driven, digitally metered dispensers wherein cylindrical piston driven jar dispensers of varying diameters are used for transferring repeatable and specific amounts of flowable compositions into smaller containers, like applicators, pumps, syringes, and jars.

### BACKGROUND

Compounding pharmacies around the globe are faced with increasing demands from regulatory bodies to meet the common day-to-day needs of filling a custom, “compounded” prescription. As result, pharmacist have less time to accomplish their daily tasks, and inefficiencies at their organizations translate to increased stress, decreased revenue, and worst case scenario, bankruptcy. Strategies to help compounding pharmacists maintain solvency are centered at streamlining execution of redundant and critical processes at their workplace, and to implement an automated system for dispensing flowable compositions in a safe and efficient manner.

Today, compounding laboratories have significant limitations for transferring flowable semi-liquid compositions from large dispensing jars to smaller containers. Furthermore, the transferring of accurate and precise dosages of semi-liquid compositions with these jar dispensers is practically non-existent, inasmuch as the commercial availability of automated digital dispensing systems (DDS).

Compounding laboratories also lack the ability to receive automated push notifications via text or email about the volume of dosages that have been dispensed for a particular drug over a desired time interval (hours, days, weeks). Likewise, the programming of custom threshold-parameters into a DDS to indicate the number of remaining doses are also non-existent.

An automated digital dispensing system (DDS) that would facilitate the transferring of flowable semi-liquid pharmaceutical preparations (FSLPP) with high accuracy and precision would certainly benefit laboratory personnel while improving the overall efficiency of these organizations. Some of the benefits would be related to maintaining superior inventory controls with compounded formulations, facilitating push notifications via text or email, being able to program threshold parameters, and having a full repertoire of pre-programmed formulation densities ready for usage when dispensing different compounds.

### SUMMARY

The various example embodiments described herein relate to a power-driven, digitally metered dispenser where cylindrical piston driven jar dispensers of varying diameters are used for transferring repeatable and specific amounts of flowable composition into smaller containers, like HRTicker® dispensers, applicators, pumps, syringes, and jars. Dosing is accomplished by dialing the desired dosage and the pressing of a push-button to dispense. The various example embodiments consist of a motor powered threaded plunger that travels in the vertical axis in accordance with a predetermined and programmed linear displacement. The end user dials the desired dispensation into the computer program via a main control dial. The desired dosage is shown on a touchscreen, liquid crystal display (LCD), or other display device. With the pressing of the same dial or push-button, the motor causes the threaded plunger to travel in the desired direction, which causes a vertical displacement on the piston of a jar dispenser. As the piston travels, it pushes on the contents inside the jar, and the medication (or other FSLPP) exits though a nozzle that is also attached to the jar. As such, the FSLPP can be transferred and collected in smaller containers.

The various example embodiments eliminate the time and necessity of manually loading smaller containers with a spatula, or other like instrument, and then having to weigh the container several times to ensure the proper amount has been transferred. Furthermore, the various example embodiments also eradicate the labor involved in physically moving rod-coupled levers to manually drive a piston with minimal to non-existent control. Lastly, the system also eradicates the guesswork and the need to develop laboratory techniques that would ensure semi-consistent results with manual loading systems that were initially developed without accuracy and precision in mind.

Piston driven jar dispensers appear to be increasingly popular with compounding pharmacies and outsourcing laboratory facilities. These jars come in different sizes, (e.g., 100, 200, 500, 1000, and 2000 milliliters). A DDS should have the ability to detect specific jar sizes, and through sensor inputs and computational analysis, configure, transfer, and/or store this jar size information for use by a control mechanism of the DDS. This DDS control mechanism can use this jar size information and related signaling information to deliver the appropriate axial and linear displacement of a threaded plunger and ultimately to the piston of a jar dispenser. The ability to detect different jar sizes can be achieved through the usage of infrared sensors arranged in a linear fashion, and each sensor collimated in its respective tunnel to prevent cross-signal interference. Thus, a specific jar diameter and related jar size can be detected by the DDS of an example embodiment.

The various example embodiments described herein provide a novel digital dispensing system that comprises a base with a digital scale, a dynamic bulkhead to hold the jar dispenser, an upper bulkhead with infrared sensors to detect the different sizes of jar dispensers, and a motor to drive a threaded plunger under programmed control. Another novelty of this dispenser system relates to having the motor on a dynamic mount to establish an actual flexure with electronic strain gauges that measure deflection. The dynamic mount flexes upwards as the threaded plunger pushes on the piston of a loaded jar dispenser and the pressure information is collected. At the base, a touchscreen, a scale platform mounted to a loading cell that detects weight, an external power-supply, and a main circuit board with a microprocessor is provided. Through the use of the programmed microprocessor or other central processing unit (CPU) as a control mechanism, we compute the deflection caused by the pressure exerted against the motor. In combination with the jar size data and the signaling information stemming from the infrared sensors for determining jar size, we are able to cause the plunger to move a desired (programmed) length, retract slightly once the dosage has been administered, and to an extent, even alert when multiple air pockets have been detected. The end user simply loads the jar into the DDS of an example embodiment and as the unit automatically detects the jar size along with the volume of semi-liquid composition present inside the jar, a series of prompts collected from the operator facilitates the proper storage of information and further processing. The end user simply dials in the desired amount to be dispensed, and with the pressing of the same dial or via a push-button, the dosage is executed. If an air pocket was present, or if the desired dosage is incomplete, a programmable jog push-button exists to complete partial doses as necessary. A scale coupled to a lower load-cell, further reassures the proper dosage is delivered. When a dispensed dosage is incomplete due to air pockets or other factors as detected by the DDS, the DDS has the ability to relay this discrepancy to the CPU. The difference between the desired volume as originally dialed, compared against the actual weight recorded on the digital scale post-dispensation is computed. As the information gets further processed, the pressing of the jog-button causes the remainder of the dosage to be dispensed.

### BRIEF DESCRIPTION OF THE DRAWINGS

The various embodiments are illustrated by way of example, and not by way of limitation, in the figures of the accompanying drawings in which:

FIG. 1 is a side view of the complete DDS. Note, an inverted piston-driven jar dispenser with a nozzle and cap are also shown;

FIG. 2 is a top view of the scale base displaying the touchscreen, balance platform, main control dial, and three push-buttons;

FIG. 3 is a top view of the base with scale, with the upper cover removed; thus, exposing the main circuit board and microprocessor(s), pole brackets, and anti-slip support, balance platform, main control dial, push-buttons, and touchscreen;

FIG. 4 is a bottom anterior view of digital dispensing system of an example embodiment;

FIG. 5 illustrates the balance platform, main circuit board with microprocessor(s), touchscreen, main-control dial, and a jog and dispense push-buttons;

FIG. 6 is a front side view of the dynamic bulk head, left and right tower poles, front gate, latches, and bearings;

FIG. 7 illustrates a left and right hollow space for the tower poles, a debossed inner face, notch edge, and notch edge space, and a nozzle void;

FIG. 8 illustrates an inverted jar dispenser with nozzle and cap. The left and right tower poles, latches, and bearings are also shown;

FIG. 9 is a top view of the DDS with the top cover tube removed to expose a NEMA 23 stepper motor with a threaded plunger and a left and right supporting poles, a static and dynamic bulkhead, and the base with a digital scale;

FIG. 10 is a bottom side view of the static bulkhead also displaying the lower face of the motor, an infrared (IR) sensor board, a threaded plunger, an upper load cell with a strain gauge, and the tower poles. In this embodiment, only three adjacent infrared sensors in a tunnel are shown, but additional (or fewer) sensors could be equivalently provided;

FIG. 11 is a bottom side view of the motor and the IR sensor board depicting three independent sensors within the board that connect to a single sensor chipset. Additional IR sensors can be added to detect additional sizes of jar dispensers;

FIG. 12 is a side view of a stepper motor with a rotor, threaded plunger, and a pair of supporting poles. An infrared sensor board, and an upper load cell are also shown near the bottom. Near the top end, a switch bar, rotation arrest bar, and a limit switch are also shown;

FIG. 13 is a side view of the threaded plunger interacting with the central wall of a fully reinforced piston;

FIG. 14 illustrates the piston, lid with central outlet, nozzle, and cap of a jar dispenser;

FIG. 15 illustrates a digital version of the touchscreen display of an example embodiment featuring the most common options of the dispenser. In this figure, a two-step process is used to dispense the correct dosage as dialed;

FIG. 16 illustrates a one step process wherein the dialed dosage is the actual dispensed dosage;

FIG. 17 is a process flow diagram illustrating an example embodiment of a system and method for controlling a power-driven, digitally metered dispenser where cylindrical piston driven jar dispensers of varying diameters are used for transferring repeatable and specific amounts of flowable composition into smaller containers;

FIG. 18 illustrates a block diagram of an example ecosystem in which the control system of an example embodiment can be implemented; and

FIG. 19 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

### An Example Embodiment of a Digital Dispensing System (DDS)

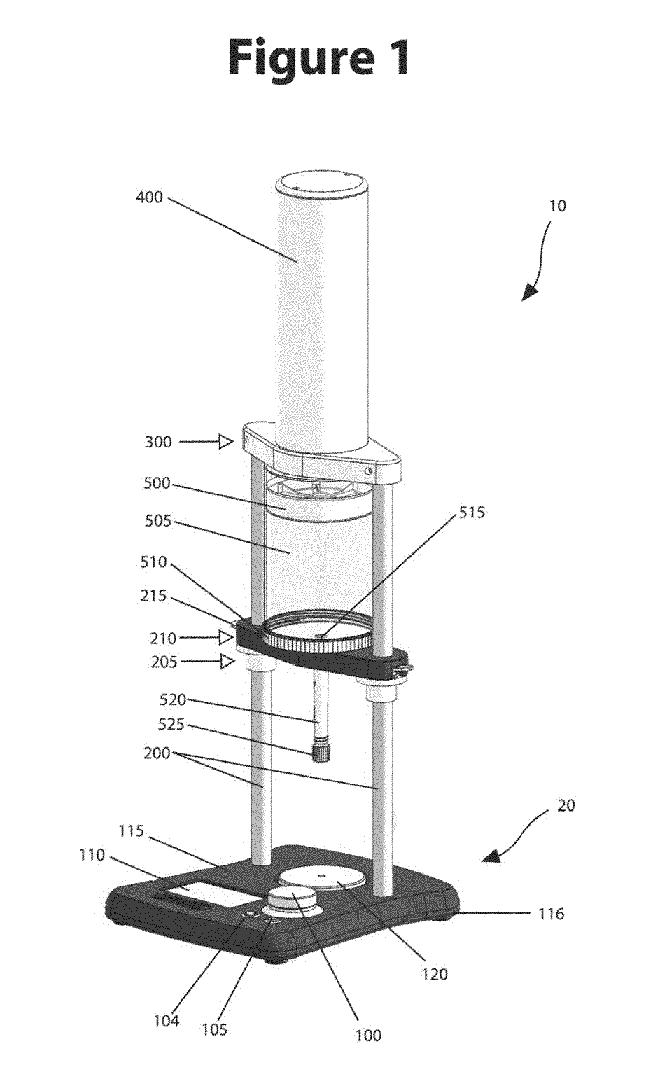

FIGS. 1-16 depict the digital dispensing system (DDS) 10 of an example embodiment. We will solely make references to a digital dispensing system for flowable compositions to encompass topical, oral, rectal, and vaginal formulations in a semi-liquid state, including but not limited to gels, suspensions, cream, pastes, and ointments general used containing pharmaceutical ingredients for use in humans and animals. As illustrated in FIG. 1, the DDS 10 is shown as a front side view with a 45 degree axial rotation on the vertical axis.

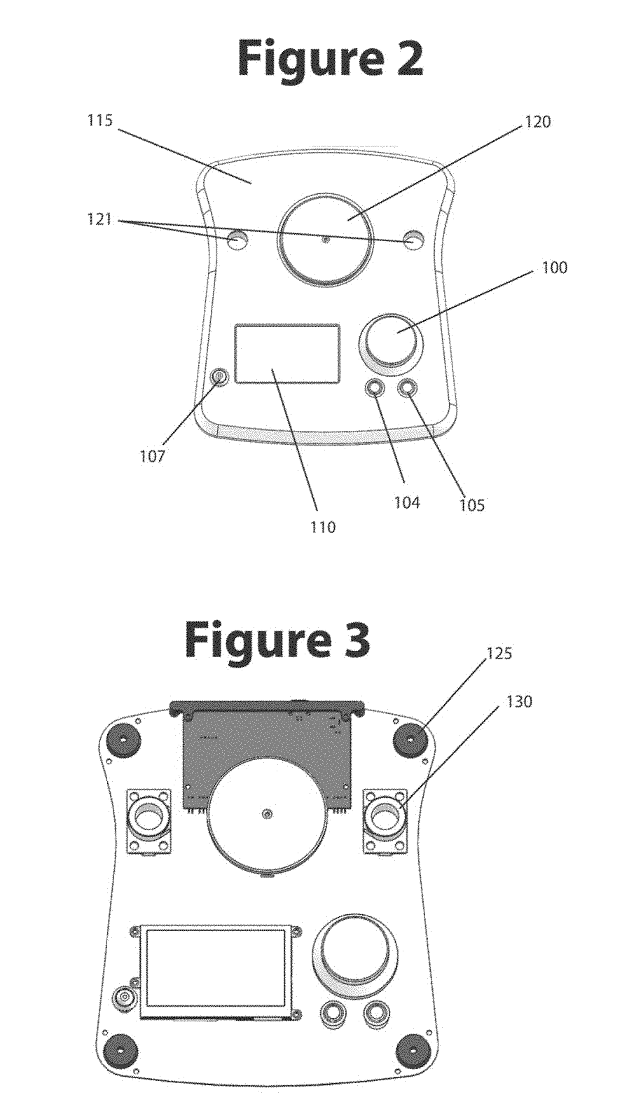

The base 20 comprises a balance 120, and main control dial 100 capable of being pushed similar to a button to trigger the dosage to be dispensed, jog button 104, a dispense push button 105, a touch screen 110, an upper case cover 115, a bottom case cover 116. FIG. 2 is a top view of the base 20 and it illustrates an additional push button 107 and a left and right tower pole anchors 121.

FIG. 3 is a top view of the base 20 with the cover removed, exposing the supporting bracket for poles 130 as well as the main circuit board with a microprocessor, USB, and Wi-Fi chipsets 135. In addition, the anti-slip supports 125 rest over a flat surface.

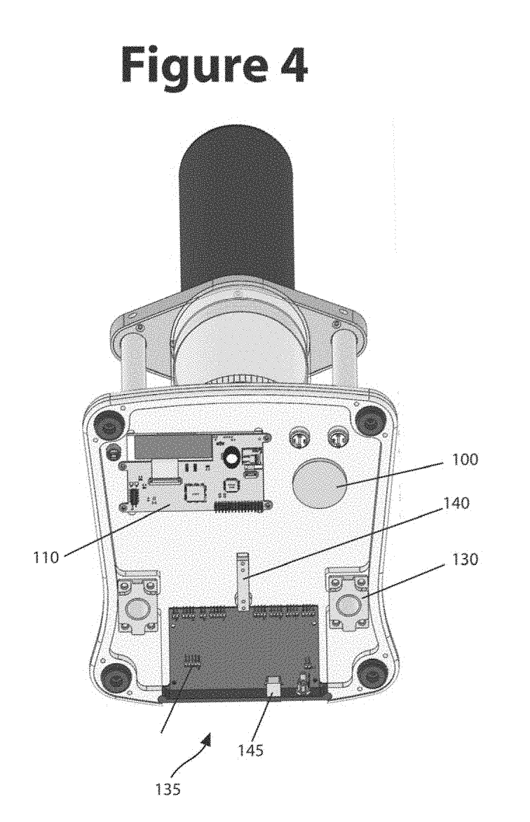

FIG. 4 is a bottom side view of the DDS 10 exposing the main circuit board with microprocessor 135 comprising a USB port 145, USB, Wi-Fi, and load-cell chipsets (not shown). Furthermore, the upper load cell 450 near the static bulkhead 300 has an integrated chipset situated at the main circuit board 135.

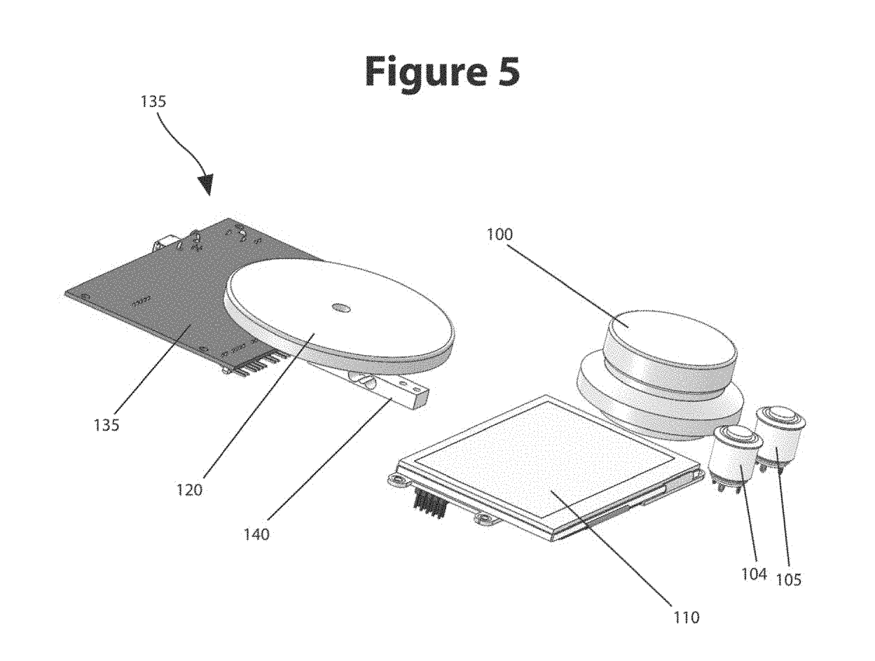

FIG. 5 is a side view of some of the components on the base 20 where the balance platform 120 is preferably positioned right above the lower load cell 140, and the circuit board with microprocessor 135. A touchscreen 110 near the front end of the base 20 positioned for viewing and changing pre-programmed parameters by the user. In addition, a jog push-button 104 and a dispensing push-button 105 are preferably positioned on the right side of the base 20, right in front of the main control dial 100, which are key for dispensing a desired dosage.

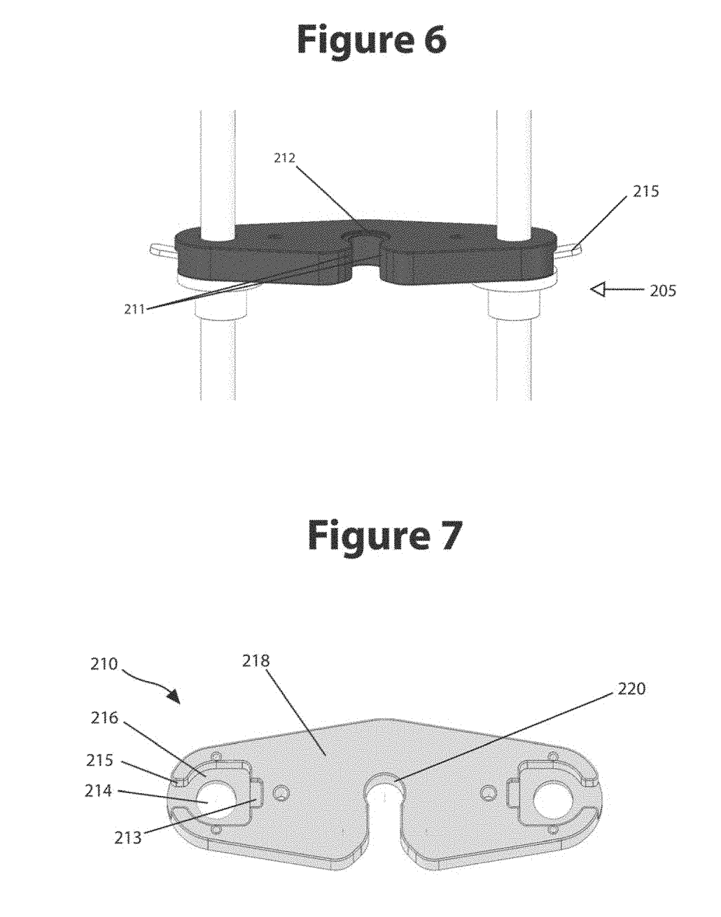

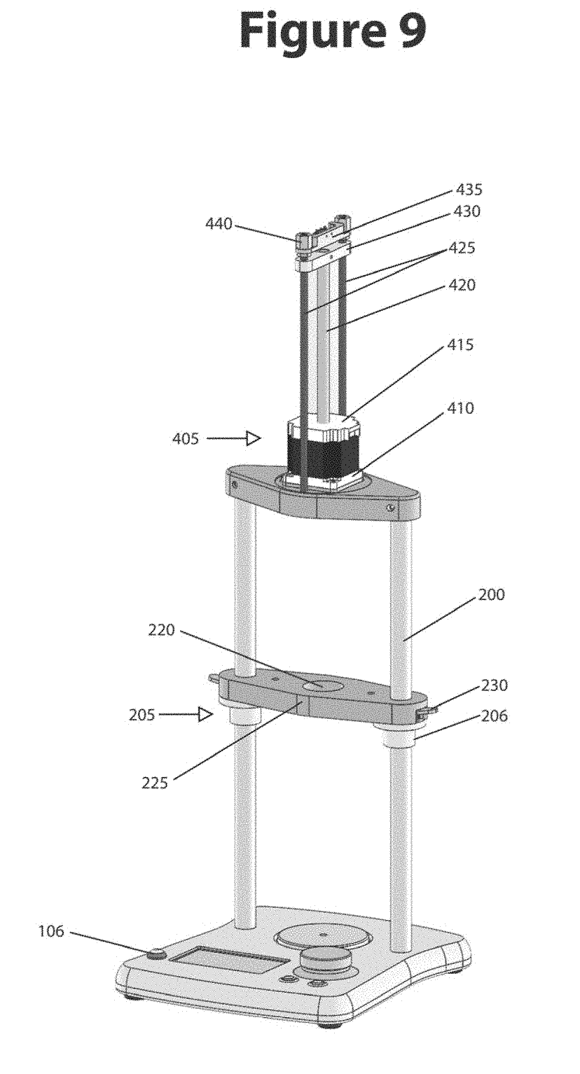

Also, as shown on FIG. 1, and FIG. 9, stemming from the base are the left and right tower poles 200 that stabilize the dynamic bulk head 210 near the middle of the system, and end by connecting to the static bulkhead 300 at the top of the DDS 10. Furthermore, as shown on FIG. 6, the left and right bearings 205 are located right underneath dynamic bulkhead 210. Any upwards or downwards traveling is made possible by a preferred pair of (left and right) latches 215 and their respective spring 208 that secure the dynamic bulkhead stationary when they are not being pressed. Nonetheless, if one pair of latches happens to be insufficient to lock the dynamic bulkhead 210 in place, an additional pair of latches 210 can be easily stacked on top of one another further locking the dynamic bulkhead in place. The springs 208 are situated right below the two latches 215, to fit into a spring cave 207. When force is exerted downwards on the latches and the spring system is compressed, the traveling of the bulkhead is allowed. The bearings move right along with the dynamic bulkhead upwards or downwards as desired by the end user.

FIG. 6 is a partial side view of the dynamic bulkhead. A nozzle connected to a lid and jar is placed upside down on the dynamic bulkhead 210. The thin end of the nozzle 520 fits within the front gate 211 to enter to the center of the nozzle void 220 of the dynamic bulkhead 210. As the jar complex gets properly positioned, the nozzle grip 521 fits snug to complement the nozzle void of the nozzle 550 and it cannot exit the dynamic bulkhead 210 unless it is first elevated and then pulled outwards. A preferred nozzle indent 212 may also exist to further secure the jar dispenser and to limit its movement.

FIG. 7 is a top view of an inverted dynamic bulkhead 210 where the lower face 218 of the dynamic bulkhead 210 is evident, along with a pair of hollow spaces 214 for accommodating the left and right tower poles 200, a notch edge space 213, a debossed inner face 216, a notch edge 215 for accommodating the latch 215, and spring 208 that fits in the spring cave 207 of the bearings 205.

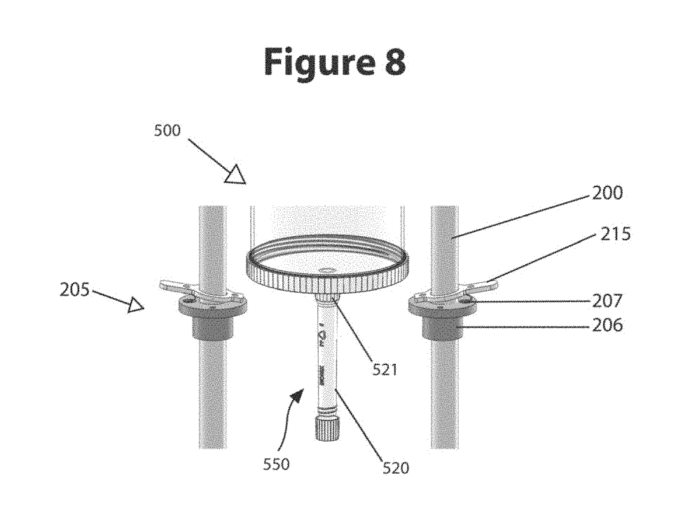

FIG. 8 is a front side view of the DDS 10 with the dynamic bulkhead 210 removed and exhibiting the dispensing jar 500, lid 514, nozzle 550 and cap 525. The bearings 205, latch 215 and tower poles 200 are clearly depicted in this exhibit. In this system, the spring 208 causes the latch 215 to be positioned at an angle against the tower poles 200; thus, restricting downwards movement and to some extent upwards movements as well. Simultaneous pressing on the latches 215 causes the spring to be coiled and further pressurized, allowing the dynamic bulkhead 210 to travel upwards or downwards as desired.

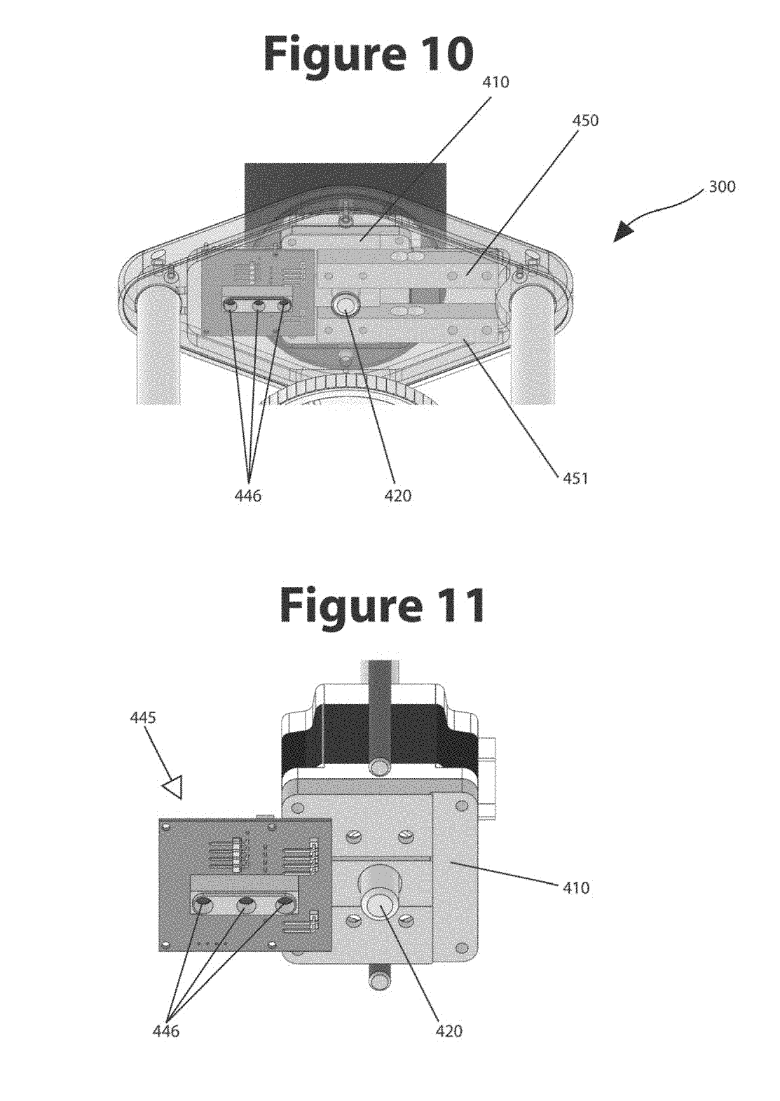

FIG. 1, 9, 10 exhibit the static bulkhead 300 situated near the top end of the DDS 10. FIG. 10 is a bottom side view of the static bulkhead 300 with transparency added to the image for better viewing. The bottom motor mount 410, is positioned on top of the active anterior 450 and posterior load cells 451; which together form the dynamic mount 452. This is a key placement in order to provide feedback about the pressure differences that take place prior to, or during dispensing, or when the plunger makes contact with the piston. In addition, FIGS. 10-11 only present the infrared sensor board 445 with three sensors as displayed. Nonetheless, at least four infrared sensors 446 are preferred in order to give us input information from a least four different jars with different diameters. A threaded plunger 420 is also evident on the center of the NEMA stepper motor 405, that interacts with its respective coupler (not shown) and two supporting rods 425 with fasteners 440, a rotation arrest bar 430, limit switch 441, and a switch bar 435.

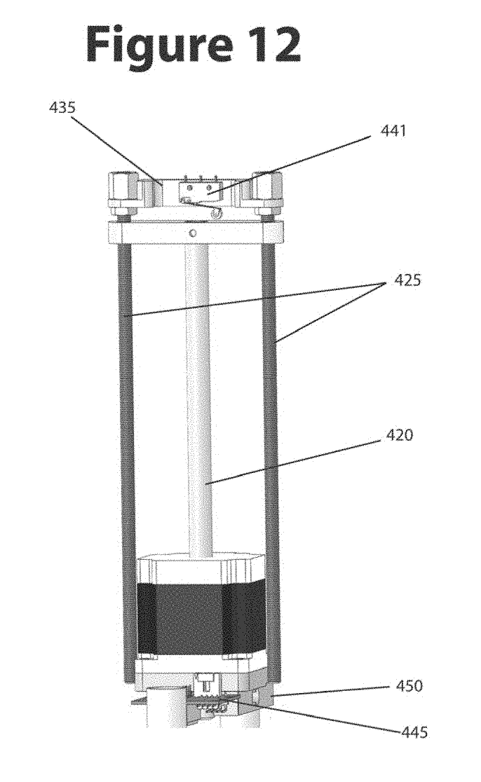

FIGS. 9, 11, and 12 exhibit a NEMA stepper motor 405. The motor is mounted on the active anterior 450 and posterior load cells 451. And a driver chipset (not shown) controls the stepper motor 405 and it is located at the main circuit board 135 of the base 20. Furthermore, an infrared sensor board with a chipset 445, which comprises at least three independent sensors, is adjacent to the upper load cells 450, 451 within the static bulkhead 210. Therefore, as force is exerted on the NEMA stepper motor 405, this information is passed from the IR sensor board 445 to the main circuit board with microprocessor 135 and changes in pressure due to piston and plunger contact, viscosity, and other factors are generally captured and processed. Additionally, FIG. 11-12 display a lower motor mount 410 a motor top cover 415, supporting poles 425, a threaded plunger 420, a rotation arrest bar 430, a switch bar 435, and a fastener 440. A limit switch 441 is situated at the very top of the DDS to prevent overpass of the threaded plunger 420, and as a baseline start for positional reference of the threaded plunger 420.

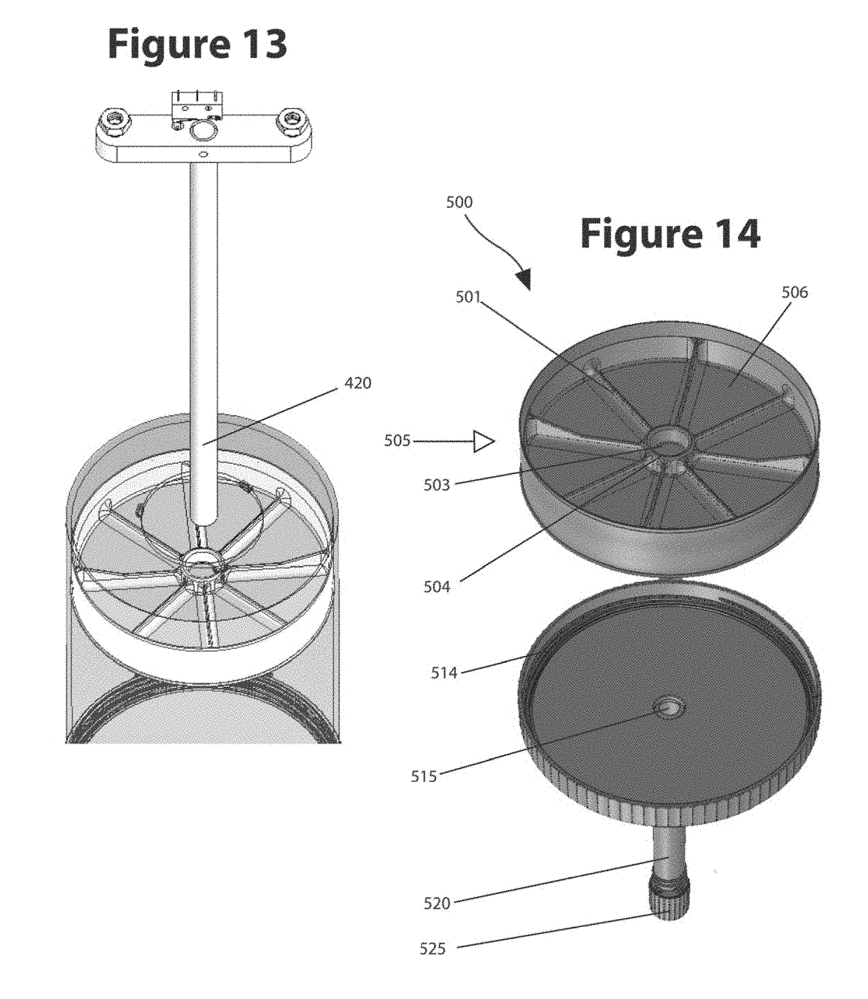

FIGS. 13 and 14 present the piston driven jar dispenser 500 for flowable compositions. In FIG. 13 the threaded plunger 420 is shown to interact with the piston 505. This piston 505 comprises a plurality of reinforced ribs 501, along with a central rim 504 designed to provide stability to the bottom wall 506 and to interact with the threaded plunger 420 of the DDS 10. As the threaded plunger 420 pushes on the center wall 503 bounded by the central rim 504, the contents inside the dispensing jar 500 exit through the outlet of the lid 515, through the nozzle 550.

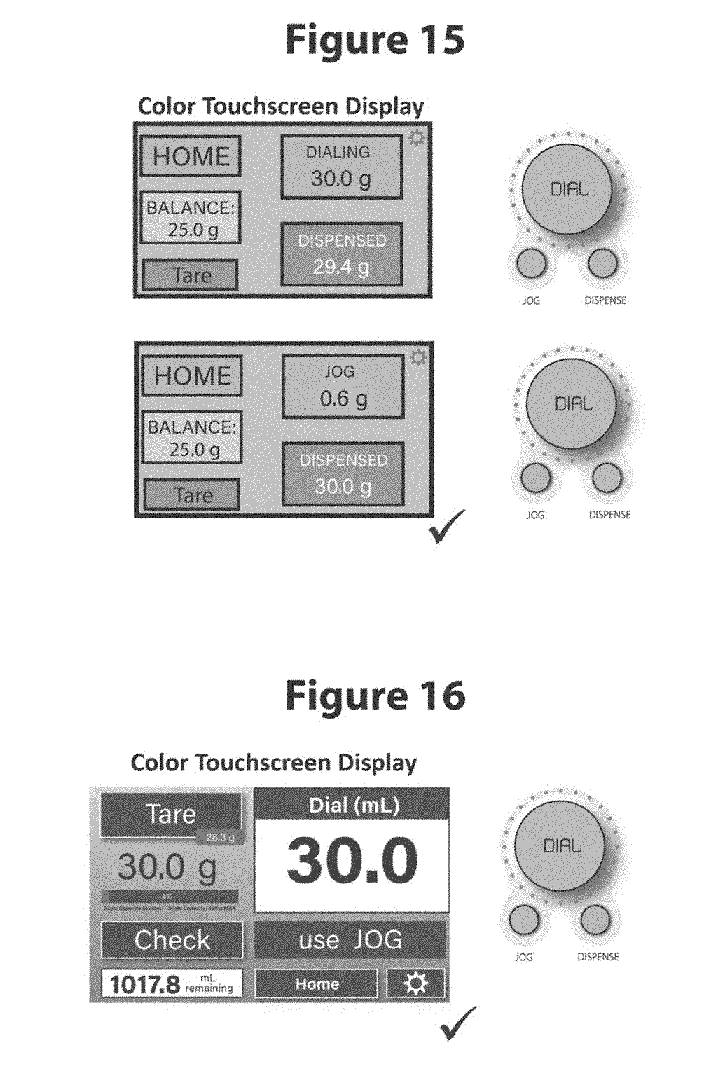

FIGS. 15 and 16 show the color touchscreen display 110, along with a cartoon representation of the main control dial 100, the jog button 104, the dispense button 105, and some of the most common features within the touchscreen. FIG. 15 shows a two-step process in order to dispense the correct dosage as dialed. First, a volume of 30 grams was dialed as it appears on screen; but only a 29.4 g was collected due to the presence of air-pockets. When the weight of the executed volume was measured on the scale, the CPU then processed that information and the jog-button was automatically set to dispense 0.6 g (The remaining dosage) in order to complete the dosage as initially dialed.

FIG. 16 illustrates a one step process where the amount initially dialed (30.0 grams), was also the exact amount dispensed. Had the dosage dispensed be 30.1 g or 30.2 g, such dosages may still fall under an acceptable margin of error, thus deemed as correct dispensations as dialed.

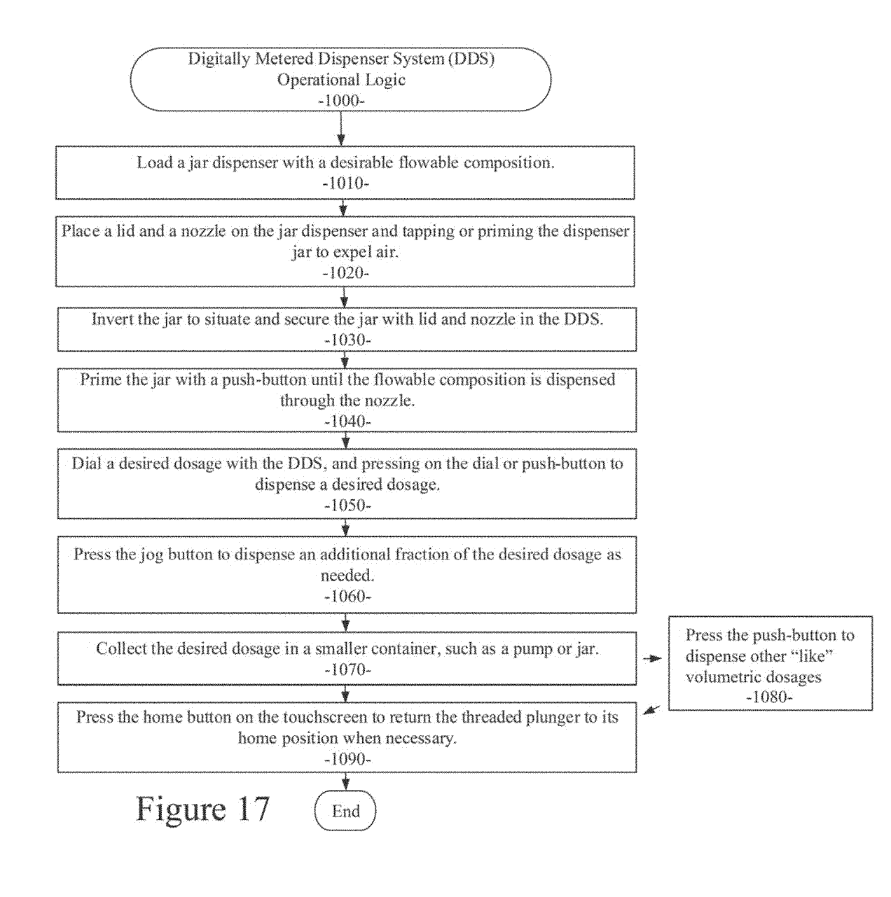

FIG. 17 is a process flow diagram illustrating an example embodiment of a system and method for controlling a power-driven, digitally metered dispenser system (DDS) where cylindrical piston driven jar dispensers of varying diameters are used for transferring repeatable and specific amounts of flowable composition into smaller containers. The example embodiment includes: loading a jar dispenser with a desirable flowable composition (processing block 1010); placing a lid and a nozzle on the jar dispenser and tapping or priming the dispenser jar to expel air (processing block 1020); inverting the jar to situate and secure the jar with lid and nozzle in the DDS (processing block 1030); priming the jar with a push-button until the flowable composition is dispensed through the nozzle (processing block 1040); dialing a desired dosage with the DDS, and pressing on the dial or push-button to dispense a desired dosage (processing block 1050); pressing the jog button to dispense an additional fraction of the desired dosage as needed (processing block 1060); collecting the desired dosage in a smaller container, such as a pump or jar (processing block 1070); and pressing the home button on the touchscreen to return the threaded plunger to its home position when necessary (processing block 1080).

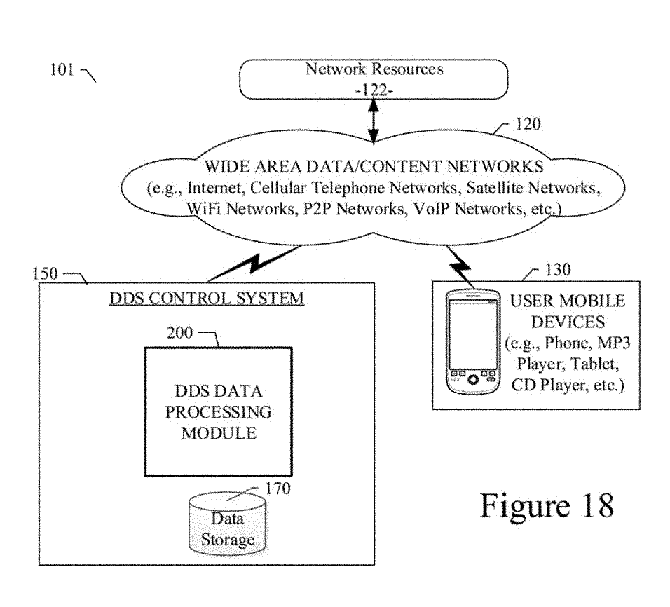

Referring now to FIG. 18, a block diagram illustrates an example ecosystem 101 in which DDS control system 150 and a DDS data processing module 200 of an example embodiment can be implemented. These components are described in more detail herein. Ecosystem 101 includes a variety of systems and components that can generate and/or deliver one or more sources of information/data and related services to the DDS control system 150 and the DDS data processing module 200. For example, the DDS control system 150 and the DDS data processing module 200 can use a wide area data/content network 120 for facilitating connectivity of the DDS control system 150 and the DDS data processing module 200 to other devices, and for wireless data communication. In the example embodiment shown, the ecosystem 101 can include a wide area data/content network 120. The network 120 represents one or more conventional wide area data/content networks, such as the Internet, a cellular telephone network, satellite network, pager network, a wireless broadcast network, WiFi network, peer-to-peer network, Voice over IP (VoIP) network, etc. One or more of these networks 120 can be used to connect a user or client system with network resources 122, such as websites, servers, product or supplier distribution sites, pharmacy sites, or the like. The network resources 122 can generate and/or distribute data, which can be received by the DDS control system 150 and the DDS data processing module 200 via the data/content network 120 and cellular, satellite, radio, or other conventional signal reception mechanisms. Such cellular data or content networks are currently available (e.g., Verizon™, AT&T™, T-Mobile™, etc.). Such satellite-based data or content networks are also currently available (e.g., SiriusXM™, HughesNet™, etc.). The conventional broadcast networks, such as AM/FM radio networks, pager networks, UHF networks, WiFi networks, peer-to-peer networks, Voice over IP (VoIP) networks, and the like are also well-known. Thus, as described in more detail herein, the DDS control system 150 and the DDS data processing module 200 can transfer web-based data or content via network 120, which can be used to connect DDS control system 150 and the DDS data processing module 200 with other network-connectible devices. In this manner, the DDS control system 150 and the DDS data processing module 200 can support a variety of network-connectable devices and systems, such as mobile devices 130. The DDS control system 150 and the DDS data processing module 200 can also support and use a variety of network resources 122 connectable via network 120.

As used herein and unless specified otherwise, the term “mobile device” includes any computing or communications device that can communicate with the DDS control system 150 and/or the DDS data processing module 200 described herein to obtain read or write access to data signals, messages, or content communicated via any mode of data communications. In many cases, the mobile device 130 is a handheld, portable device, such as a smart phone, mobile phone, cellular telephone, tablet computer, laptop computer, display pager, radio frequency (RF) device, infrared (IR) device, global positioning device (GPS), Personal Digital Assistants (PDA), handheld computers, wearable computer, portable game console, other mobile communication and/or computing device, or an integrated device combining one or more of the preceding devices, and the like. Additionally, the mobile device 130 can be a computing device, personal computer (PC), multiprocessor system, microprocessor-based or programmable consumer electronic device, network PC, diagnostics equipment, a system operated by a vehicle 119 manufacturer or service technician, and the like, and is not limited to portable devices. The mobile device 130 can receive and process data in any of a variety of data formats. The data format may include or be configured to operate with any programming format, protocol, or language including, but not limited to, JavaScript™, C++, iOS, Android™, etc.

As used herein and unless specified otherwise, the term “network resource” includes any device, system, or service that can communicate with the DDS control system 150 and/or the DDS data processing module 200 described herein to obtain read or write access to data signals, messages, or content communicated via any mode of inter-process or networked data communications. In many cases, the network resource 122 is a data network accessible computing platform, including client or server computers, websites, mobile devices, peer-to-peer (P2P) network nodes, and the like. Additionally, the network resource 122 can be a web appliance, a network router, switch, bridge, gateway, diagnostics equipment, a system operated by a vehicle 119 manufacturer or service technician, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein. The network resources 122 may include any of a variety of providers or processors of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3—MP3, and the like), video (e.g., MP4, and the like), and any proprietary interchange format defined by specific content sites can be supported by the various embodiments described herein.

The wide area data network 120 (also denoted the network cloud) used with the network resources 122 can be configured to couple one computing or communication device with another computing or communication device. The network may be enabled to employ any form of computer readable data or media for communicating information from one electronic device to another. The network 120 can include the Internet in addition to other wide area networks (WANs), cellular telephone networks, metro-area networks, local area networks (LANs), other packet-switched networks, circuit-switched networks, direct data connections, such as through a universal serial bus (USB) or Ethernet port, other forms of computer-readable media, or any combination thereof. The network 120 can include the Internet in addition to other wide area networks (WANs), cellular telephone networks, satellite networks, over-the-air broadcast networks, AM/FM radio networks, pager networks, UHF networks, other broadcast networks, gaming networks, WiFi networks, peer-to-peer networks, Voice Over IP (VoIP) networks, metro-area networks, local area networks (LANs), other packet-switched networks, circuit-switched networks, direct data connections, such as through a universal serial bus (USB) or Ethernet port, other forms of computer-readable media, or any combination thereof. On an interconnected set of networks, including those based on differing architectures and protocols, a router or gateway can act as a link between networks, enabling messages to be sent between computing devices on different networks. Also, communication links within networks can typically include twisted wire pair cabling, USB, Firewire™, Ethernet, or coaxial cable, while communication links between networks may utilize analog or digital telephone lines, full or fractional dedicated digital lines including T1, T2, T3, and T4, Integrated Services Digital Networks (ISDNs), Digital User Lines (DSLs), wireless links including satellite links, cellular telephone links, or other communication links known to those of ordinary skill in the art. Furthermore, remote computers and other related electronic devices can be remotely connected to the network via a modem and temporary telephone link.

The network 120 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network may also include an autonomous system of terminals, gateways, routers, and the like connected by wireless radio links or wireless transceivers. These connectors may be configured to move freely and randomly and organize themselves arbitrarily, such that the topology of the network may change rapidly. The network 120 may further employ one or more of a plurality of standard wireless and/or cellular protocols or access technologies including those set forth herein in connection with network interface 712 and network 714 described in the figures herewith.

In a particular embodiment, a mobile device 130 and/or a network resource 122 may act as a client device enabling a user to access and use the DDS control system 150 and/or the DDS data processing module 200 via network 120. These client devices 130 or 122 may include virtually any computing device that is configured to send and receive information over a network, such as network 120 as described herein. Such client devices may include mobile devices, such as cellular telephones, smart phones, tablet computers, display pagers, radio frequency (RF) devices, infrared (IR) devices, global positioning devices (GPS), Personal Digital Assistants (PDAs), handheld computers, wearable computers, integrated devices combining one or more of the preceding devices, and the like. The client devices may also include other computing devices, such as personal computers (PCs), multiprocessor systems, microprocessor-based or programmable consumer electronics, network PC's, and the like. As such, client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a color LCD display screen in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission. The client application may include a capability to provide and receive textual content, graphical content, video content, audio content, alerts, messages, notifications, and the like. Moreover, the client devices may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. The client devices may also include a wireless application device on which a client application is configured to enable a user of the device to send and receive information to/from network resources wirelessly via the network.

The DDS control system 150 and/or the DDS data processing module 200 can be implemented using systems that enhance the security of the execution environment, thereby improving security and reducing the possibility that the DDS control system 150 and/or the DDS data processing module 200 and the related services could be compromised by viruses or malware. For example, the DDS control system 150 and/or the DDS data processing module 200 can be implemented using a Trusted Execution Environment, which can ensure that sensitive data is stored, processed, and communicated in a secure way.

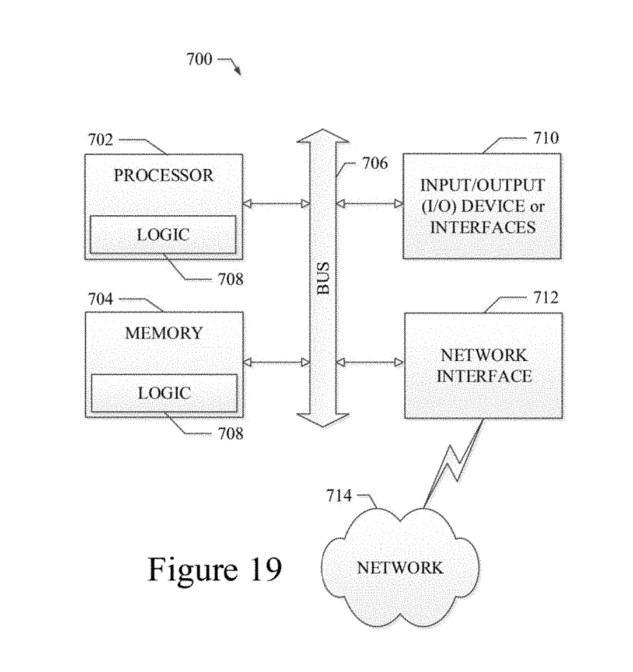

FIG. 19 illustrates a diagrammatic representation of a machine in the example form of a computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be or operate with a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example computing and/or communication system 700 can include a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, a voice interface, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication and data processing mechanisms by which information/data may travel between a mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

In various embodiments as described herein, example embodiments include at least the following examples.
1. A digital dispensing system for transferring specific volumetric quantities of flowable compositions, comprising:
   a. A base with or without a scale
   b. A dynamic bulkhead
   c. A static bulkhead
   d. An electric motor
   e. Two parallel tower poles
2. The base of the DDS as claimed above further comprising:
   a. A preferred scale with a lower load cell and corresponding spring gauge.
   b. A programmable rotable main control dial for priming, measuring, and dispensing a desired dosage.
   c. A programmable push jog-button and dispense-button for priming, and dispensing a desired dosage.
   d. A touchscreen or LCD screen for displaying information and for facilitating changes in program settings.
   e. An on/off switch.
   f. A main circuit board with a microprocessor, USB, load-cell, and Wi-Fi chipsets for analyzing and executing different processes, for facilitating connectivity to other devices, and for wireless data transmission.
   g. An external AC power adapter for transforming standard household AC electricity, to a lower DC voltage.
3. The DDS as claimed above where a scale platform is situated on top of a lower load cell to provide digital weight information to a user, and to relay weight information to the CPU for further processing.
4. The DDS as claimed above, where the scale weight relays information to the CPU for further processing of present and future dispensations.
5. The DDS as claimed above, with a plurality of programmable main control dials and push-buttons for measuring, dispensing, and priming a desired dosage.
6. The DDS as claimed above with a programmable touchscreen or an LCD screen to display DDS information about dispensations, weight, air pockets, changes in pressure, clogs, and other related parameters.
7. The DDS as claimed above housing a left and right support bracket, each housing a tower pole perpendicular to the base.
8. The DDS as claimed above comprising a main circuit board with a central processing unit and an optional scale platform with a load-cell chipset.
9. The dispensing system as claimed above where the motor is coupled to a dynamic mount for sensing the pressure acting on the piston of the jar with direct feedback to the CPU.
10. The DDS as claimed above where the conducting wiring to power the motor and the other electrical components run internally from the base, through the inside of the tower poles and exit on the upper-side of the static bulkhead.
11. The dispensing system as claimed above where at least one upper load cell on the static bulkhead is used for sensing pressure acting on the threaded plunger.
12. The digital dispensing system as claimed above with adjacent infrared sensors to detect different sizes of piston-driven jar-dispensers. Each sensor preferably housed inside a tunnel to minimize signal cross-interference.
13. The DDS as claimed above where at least one IR photo sensor has a dedicated sensor chipset for relaying information to the main microprocessor.
14. The digital dispensing system as claimed above configured with a dynamic mount to detect changes on pressure such as, clogs inside the jar, clogs in the nozzle, and stalls that may pertain to jar malfunction.
15. The DDS as claimed above with a secondary dynamic bulkhead near the base, used as a container support tray and to store a limited supply of smaller containers.
16. The DDS as claimed above where the plunger has a pre-programmed algorithm to minimally retract right after every dispensation to minimize after-drip.
17. DDS as claimed above formed from a variety of materials like, but not limited to aluminum, steel, metallic materials, solid plastics, elastomeric materials, and other similar substances for rigid support and structure.
18. The central processing unit (CPU) of the DDS as claimed above configured to collect jar size information from the sensor board to properly process dispensation adjustments in volume.
19. The dynamic bulkhead as claimed above comprising:
   a. A left and right latch and spring lock system that interact with the tower pole
   b. A left and a right bearing immediately underneath the dynamic bulkhead
   c. A central void near two front gates to accommodate and secure a nozzle and a lid.
   d. Optional infrared sensors to further detect different dispenser jar diameters and sizes.
   e. An optional dual assisted spring suspension for pushing the dynamic bulkhead upwards to assist in loading the jar assembly into the system.
   f. The ability to slide upwards and downwards, as limited by the base and static bulkhead, provided the latch system has been pressed to release the dynamic bulkhead.
   g. The ability to accept a jar assembly by moving it forward in the horizontally axis, and then letting it drop vertically to secure the nozzle and the jar assembly in place.
   h. An optional closed gate to load the nozzle and dispensing jar solely from the vertical axis.
   i. A spring and latch system to secure and to slide the dynamic bulkhead to a desired location along the vertical axis.
   j. An alternate pin and hole locking system to further secure the dynamic bulkhead in place along the vertical axis.
20. The dynamic bulkhead as claimed above comprising an optional infrared-sensor board where the signal information inputs to the main circuit board with microprocessor.
21. The static bulkhead as claimed above further comprising:
   a. A central void to accommodate a threaded plunger.
   b. At least one upper load cells for sensing weight and pressure changes.
   c. A sensor board comprising a plurality of infrared sensors to identify different diameter sizes of piston-driven jar dispensers.
   d. An optional spring-and-latch or pin-to-hole locking-system to secure the static bulkhead at a desired location.
22. The IR sensors as claimed above arranged in a preferred linear arrangement, adjacent to one another to detect different diameter sizes of piston-driven jar dispensers.
23. The static bulkhead as claimed above where the static bulkhead can be modified to be a dynamic bulkhead, and the dynamic bulkhead modified to be a static bulkhead.
24. The NEMA stepper electrical motor as claimed above, further comprising:
   a. A threaded plunger
   b. A coupler that interacts with the threaded plunger
   c. At least two adjacent supporting rods to stabilize and secure the motor in place.
   d. A supporting rotation arrest bar near the top end of the DDS.
   e. A limit switch and fastener to shut off, prevent overdrive of the threaded plunger, and to establish a baseline point of reference for the exact location of the threaded plunger.
   f. A motor mount preferably coupled to an anterior and posterior load-cells to detect changes in pressure.
   g. A stepper motor chipset located at the main circuit board with the microprocessor.
   h. A tube cover to enclose the motor associated components and further minimize noise.
25. The microprocessor on the DDS as claimed above comprising:
   a. The ability to detect and compute different diameter sizes of piston-driven jar dispensers through the IR sensors as claimed above and the corresponding sensory chipsets.
   b. The ability to detect the pressure differences exerted on the motor through the signaling inputs from the upper load cells situated on the static bulkhead.
   c. The ability to detect changes in pressure such as viscosity changes or air pockets within the semi-liquid preparation inside the piston-driven jar dispenser.
   d. The ability to alert the operator shall a viscosity change or if the presence of excessive air pockets occurs.
   e. The ability to automatically retract the threaded plunger preferably after every dosage completion to minimize after-drip.
   f. The ability to alert, modify, or stop a dosage execution based on the weight information from the lower load-cell.
   g. The ability to fine-tune a dosage being dispensed consistent with pre-programmed information regarding different base densities.
   h. The ability to relay information of different processes and actions to an external drive.
   i. The ability to maintain a record of compositions and drug-mixtures dispensed.
   j. The ability to send push-alerts based on thresholds of pre-programmed parameters.
   k. The ability to transmit wireless information to a network or cloud via Wi-Fi.
   l. The ability to transmit information, and updates in firmware through hardwired USB connectivity.
   m. The ability to automatically power off the touchscreen display.
   n. The ability to process and execute a repeat in like-dosages through the pressing of a dial push-button.
   o. The ability to process and execute a different dosage dispensation through the use of the same dial push-button.
   p. The ability to compute calibration, taring, and weight measurements of semi-liquid compositions and devices.
   q. The ability to detect the volume of a semi-liquid preparation inside a piston-driven jar dispenser.
   r. The ability to detect how much flowable preparation remains on a jar dispenser prior to, during, and after a dispensation.
   s. The ability to identify a clog on the jar, nozzle, or piston through pre-programmed pressure threshold activation.
   t. The ability to auto-compensate for under-dosage executions of flowable compositions with the use of a push-button, consistent with the weight information of a feedback loop and a desired dosage as dialed.
26. The sensor board as claimed above comprising:
   a. A plurality of infrared-sensors each situated in a tunnel to detect the diameter of different sizes of jar dispensers, and to minimize signal interference.
   b. At least one dedicated infrared chipset.
   c. Other sensory board components as generally necessary.
27. A method for automated dispensing using a DDS comprising:
   a. Loading a jar dispenser with a desirable flowable composition
   b. Placing a lid and a nozzle on the jar dispenser.
   c. Tapping and priming the dispenser jar to expel air.
   d. Inverting the jar to situate and secure the jar with lid and nozzle in the DDS
   e. Prime the jar with a push-button until the flowable composition is dispensed through the nozzle.
   f. Dialing a desired dosage with the DDS, and pressing on the dial or push-button to dispense a desired dosage.
   g. Pressing of the jog button shall an additional fraction of the desired dosage is needed.
   h. Collecting the desired dosage in a smaller container such as a pump or jar.
   i. Repeating this process when necessary to dispense additional volumes into other containers.
   j. Pressing the home button on the touchscreen to return the threaded plunger to its home position when necessary.
28. The method as claimed above where:
   a. The main control dial is repeatedly pressed as many times to dispense the same dosage provided there is sufficient flowable composition inside the jar to be dispensed.
   b. The main control dial can be re-dialed to dispense different dosages.
   c. The DDS has the ability to alert when the flowable composition inside the jar dispenser drops to low levels.
   d. The DDS has the ability to dispense a dosage in instances when the volume of the dialed amount is less than the volume inside the jar dispenser.
   e. The piston driven jar dispenser may be an electric mortar and pestle (EMP) jar.
   f. The flowable composition may be a thick suspension, gel, ointment, or cream with or without pharmaceutical ingredients.
29. A method for weight calibration of any flowable formulation where:
   a. The names of each formulation is stored
   b. For each given formulation, dialing a fixed dosage, and pressing the dispense button to execute the same volumetric dosage for “X” number of times as desired, or as possible based on the jar size and the volume inside the jar.
   c. Taking the average volumetric weight of each dispensation above and recording it.
   d. In accordance to the average weight recorded from the data collected, computing the necessary volume compensation for future dispensations of the calibrated formulation.
   e. Storing the information above on the DDS for future usage.
30. A method of auto-detection with partial and full dispensations:
1. User loads a desired piston-driven jar dispenser
2. Once the jar gets properly inserted, the sensors detect its size and threaded plunger automatically starts to travel in order to engage with the piston.
3. Once piston and threaded plunger make contact, the threaded plunger and motor stops.
4. The DDS prompts user: Amount of composition detected in the jar (Related to the position of the piston inside the jar dispenser) is displayed on the side of the screen; and the unit is ready to dispense.
5. The user dials a desired dosage (i.e., 20 g, 35 g, etc.) and the dosage appears on the digital screen.
6. Next, the user presses the dispenser push-button to execute the dosage. Alternatively, the main dial control can also be used to dispense the dosage.
7. As the push-button is pressed, the motor powers up, and the flowable composition exits the jar dispenser through the nozzle to be collected into smaller containers.
8. Next, once the medication has been dispensed, motor stops, and the smaller container gets placed on the scale platform. If the amount dispensed is under the desired dialed amount, that information gets processed, and the difference in dosage is automatically ready to be dispensed via jog button.
9. Once the jog button is pressed, a smaller fraction of the original dialed amount further exits the larger container to complete the dosage. Note, if the dosage dispensed the first time was precise, (Within a pre-programmed acceptance of error), then no additional dosage get dispensed.
10. Next, the user removes the container from the DDS and further proceeds with packaging, or with the filling of additional containers.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, example embodiments relate to a power-driven, digitally metered dispenser where cylindrical piston driven jar dispensers of varying diameters are used for transferring repeatable and specific amounts of flowable composition into smaller containers, like HRTicker® dispensers, applicators, pumps, syringes, and jars. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A digital dispensing system for transferring specific volumetric quantities of flowable compositions, the system comprising:
a base;
a central processing unit (CPU) operating as a control mechanism housed in the base;
parallel tower poles stemming from the base;
a static bulkhead coupled to the parallel tower poles;
an electric motor coupled to the static bulkhead; and
a dynamic bulkhead captured between the base and the static bulkhead, the dynamic bulkhead being stabilized by the parallel tower poles.

2. The system of claim 1 wherein the base includes a scale.

3. The system of claim 1 wherein the base further comprising:
a preferred scale with a lower load cell and corresponding spring gauge;
a programmable rotatable main control dial for priming, measuring, and dispensing a desired dosage;
a programmable push jog-button and dispense-button for priming, and dispensing a desired dosage;
a display device for displaying information and for facilitating changes in program settings;
an on/off switch;
a main circuit board with a microprocessor, USB, load-cell, and Wi-Fi chipsets for analyzing and executing different processes, for facilitating connectivity to other devices, and for wireless data transmission; and
an external AC power adapter for transforming standard household AC electricity to a lower DC voltage.

4. The system of claim 1 including a scale platform situated on top of a lower load cell to provide digital weight information to a user, and to relay weight information to the CPU for further processing.

5. The system of claim 1 including a scale, wherein the scale relays weight information to the CPU for further processing of present and future dispensations.

6. The system of claim 1 including a plurality of programmable main control dials and push-buttons for measuring, dispensing, and priming a desired dosage.

7. The system of claim 1 including a programmable display device to display information related to dispensations, weight, air pockets, changes in pressure, clogs, and other related parameters.

8. The system of claim 1 including a left and right support bracket, each support bracket housing one of the parallel tower poles and positioned perpendicular to the base.

9. The system of claim 1 including a main circuit board comprising a microprocessor, a load cell chipset for a digital scale, a load cell chipset for sensing pressure acting on a piston, a sensor chipset for detecting photo-infrared information of different jar sizes, a chipset for the stepper motor, a USB chipset, a chipset for the touchscreen, and other standard components that make-up a circuit board.

10. The system of claim 1 wherein the electric stepper motor being coupled to a dynamic mount for sensing the pressure acting on a piston of a jar with direct feedback to the CPU.

11. The system of claim 1 wherein conducting wiring to power the electric motor and other electrical components runs internally from the base, through the inside of the parallel tower poles and exits on an upper-side of the static bulkhead.

12. The system of claim 1 wherein at least one upper load cell on the static bulkhead is used for sensing pressure acting on a threaded plunger.

13. The system of claim 1 including adjacent infrared sensors to detect different sizes of piston-driven jar-dispensers, each sensor being housed inside a tunnel to minimize signal cross-interference.

14. The system of claim 1 including adjacent infrared sensors to detect different sizes of piston-driven jar-dispensers, where at least one infrared sensor has a dedicated sensor chipset for relaying information to the CPU.

15. The system of claim 1 including a dynamic mount to detect changes on pressure, including clogs inside a jar, clogs in a nozzle, and stalls that may pertain to jar malfunction.

16. The system of claim 1 including a secondary dynamic bulkhead near the base for use as a container support tray and to store a limited supply of smaller containers.

17. The system of claim 1 including a plunger automatically programmed to minimally retract after every dispensation to minimize after-drip.

18. The system of claim 1 wherein the base, the parallel tower poles, the static bulkhead, and the dynamic bulkhead are formed of materials from the group consisting of: aluminum, steel, metallic materials, solid plastics, elastomeric materials, and rigid support and structure materials.

19. The system of claim 1 wherein the CPU is configured to collect jar size information from a sensor board to properly process dispensation adjustments in volume.

20. The system of claim 1 wherein the static bulkhead of further comprising a central void to accommodate a threaded plunger.
